(19) United States
(12) Patent Application Publication
(10) Pub. No.: US 2025/0015490 A1
(43) Pub. Date: Jan. 9, 2025

(54) Antenna Assembly and Electronic Device

(71) Applicant: Huawei Technologies Co., Ltd., Shenzhen (CN)

(72) Inventors: Zongze Li, Shanghai (CN); Yanbo Li, Wuhan (CN); Wenjun Chen, Wuhan (CN); Jun You, Wuhan (CN); Kemeng Wang, Dongguan (CN)

(21) Appl. No.: 18/713,372

(22) PCT Filed: May 13, 2022
(86) PCT No.: PCT/CN2022/092826

§ 371 Date: May 24, 2024

(30) Foreign Application Priority Data
Dec. 6, 2021 (CN) 202123040809.1

(51) Int. Cl. H01Q 1/52; H01Q 1/22; H01Q 1/48

(52) U.S. Cl. CPC H01Q 1/521; H01Q 1/22; H01Q 1/48

(57) ABSTRACT

An antenna assembly includes a first radiator, a second radiator, a feeding structure, and a decoupling apparatus. The first radiator includes a first radiation branch and a second radiation branch that have opposite bending directions, and a first gap exists between the first radiation branch and the second radiation branch. The second radiator includes a third radiation branch and a fourth radiation branch that have opposite bending directions, and a second gap exists between the third radiation branch and the fourth radiation branch. The feeding structure is electrically coupled to the first radiation branch and the third radiation branch. The first radiator and the second radiator share a common part, the common part is a common branch, and the common branch is electrically coupled to a grounding terminal of the antenna assembly through the decoupling apparatus.

This application claims priority to Chinese Patent Application No. 202123040809.1, filed with the China National Intellectual Property Administration on Dec. 6, 2021 and entitled “ANTENNA ASSEMBLY AND ELECTRONIC DEVICE”, which is incorporated herein by reference in its entirety.

### TECHNICAL FIELD

This application relates to the field of antenna technologies, and in particular, to an antenna assembly and an electronic device.

### BACKGROUND

With application and development of a terminal electronic device, a user has an increasingly high requirement for working performance of the electronic device. The electronic device is provided with an antenna assembly. The antenna assembly includes a plurality of radiators that can transmit signals of a specific frequency. The radiators have a plurality of working frequencies, to increase application scenarios of the electronic device. In addition, the plurality of radiators can work in a same frequency band at the same time, to meet a requirement of the electronic device for processing a large throughput and a plurality of data streams. Generally, when the plurality of radiators work at the same time, adjacent radiators affect each other. Consequently, quality of a signal transmitted by the radiator is poor, and stability of receiving and sending a signal by the electronic device is poor.

### SUMMARY

This application provides an antenna assembly and an electronic device, to reduce interference between adjacent radiators, and improve stability of receiving and sending a signal by the electronic device.

A first aspect of this application provides an antenna assembly, where the antenna assembly includes:
a first radiator, where the first radiator includes a first radiation branch and a second radiation branch that have opposite bending directions, and a first gap exists between the first radiation branch and the second radiation branch;
a second radiator, where the second radiator includes a third radiation branch and a fourth radiation branch that have opposite bending directions, and a second gap exists between the third radiation branch and the fourth radiation branch, where
the first radiator and the second radiator share a common part, and the common part is a common branch;
a feeding structure, where the feeding structure is electrically connected to the first radiation branch and the third radiation branch; and
a decoupling apparatus, where the decoupling apparatus is disposed on the common branch, and the common branch is electrically connected to a grounding terminal of the antenna assembly through the decoupling apparatus.

In this application, interference between the first radiator and the second radiator is reduced by using the decoupling apparatus, so that quality of signals transmitted by the first radiator and the second radiator is improved. In this way, stability of receiving and sending a signal by the electronic device is improved, accuracy of signal processing performed by the electronic device is improved, and use performance of the electronic device is improved.

In a possible design, the first radiation branch and the third radiation branch are integrally arranged, or the second radiation branch and the fourth radiation branch are integrally arranged, to form the common branch.

In this application, the second radiation branch and the fourth radiation branch are integrally arranged, or the first radiation branch and the third radiation branch are integrally arranged. This increases flexibility of a structure of the antenna assembly, and increases flexibility of an installation position of the feeding structure, to facilitate installation of the antenna assembly.

In a possible design, the first radiation branch and the third radiation branch that are integrally arranged join into a T-shaped structure, or the second radiation branch and the fourth radiation branch that are integrally arranged join into a T-shaped structure.

In this application, the two radiation branches that are integrally arranged join into the T-shaped structure, so that structures of the second radiation branch, the fourth radiation branch, the first radiation branch, and the third radiation branch are simplified. In this way, a size of the antenna assembly is reduced, and space required for installing the antenna assembly is reduced.

In a possible design, the first radiator further includes at least one fifth radiation branch, where the fifth radiation branch is connected to the first radiation branch, and/or the fifth radiation branch is connected to the second radiation branch.

The second radiator further includes at least one sixth radiation branch, the sixth radiation branch is connected to the third radiation branch, and/or the sixth radiation branch is connected to the fourth radiation branch.

In this application, both the first radiator and the second radiator include a plurality of radiation branches that can resonate with a signal of a specific frequency, to widen a frequency range of signals that can be transmitted by the first radiator and the second radiator. In this way, working performance of the first radiator and the second radiator is improved, and working performance and an application scope of the antenna assembly and the electronic device are improved.

In a possible design, the at least one fifth radiation branch and the at least one sixth radiation branch are connected to the common branch, and the fifth radiation branch and the sixth radiation branch divide the common branch into a plurality of segments.

There is one decoupling apparatus, and the decoupling apparatus is disposed on a segment that is of the common branch and that is close to the grounding terminal.

In this application, the decoupling apparatus is disposed on a segment that is of the common branch and that is close to the grounding terminal, so that the decoupling apparatus can decouple the antenna assembly when the antenna assembly works in any frequency band. In this way, working reliability of the decoupling apparatus is improved, and working stability of the antenna assembly and the electronic device is improved.

In a possible design, the at least one fifth radiation branch and the at least one sixth radiation branch are connected to the common branch, and the fifth radiation branch and the sixth radiation branch divide the common branch into a plurality of segments.

There are a plurality of decoupling apparatuses, and the decoupling apparatus is disposed on each segment of the common branch.

In this application, the decoupling apparatus is disposed on each segment of the common branch. When one decoupling apparatus is short-circuited, other decoupling apparatuses can also work normally. In this way, working reliability of the decoupling apparatus is improved, and working stability of the antenna assembly and the electronic device is improved.

In a possible design, the first radiation branch, the second radiation branch, and the grounding terminal enclose a first space, and the third radiation branch, the fourth radiation branch, and the grounding terminal enclose a second space.

The antenna assembly further includes at least one first protrusion part and at least one second protrusion part, and both the first protrusion part and the second protrusion part are connected to the grounding terminal. The first protrusion part is disposed in the first space, and the second protrusion part is disposed in the second space.

In this application, the first protrusion part and the second protrusion part change a distance between the first radiator and the grounding terminal and a distance between the second radiator and the grounding terminal, to change a coupling relationship between the first radiation branch and the second radiation branch and a coupling relationship between the third radiation branch and the fourth radiation branch. In this way, interference between the first radiator and the second radiator is reduced, and working stability of the first radiator and the second radiator is improved.

In a possible design, the decoupling apparatus includes one or more decoupling capacitors.

The decoupling apparatus is formed by lumped elements, and/or the decoupling apparatus is formed by a distributed parameter structure.

In this application, when the first radiator resonates with a signal of a specific frequency, energy is generated and radiated to the outside. In this case, the decoupling capacitor can absorb some energy radiated by the first radiator, to prevent the energy radiated by the first radiator from interfering with resonance between the second radiator and the signal, so that working stability of the second radiator is improved.

In a possible design, the decoupling apparatus includes a decoupling capacitor and an inductor. There are one or more decoupling capacitors, and there are one or more inductors.

A plurality of decoupling capacitors are connected in series to the inductor, and/or the plurality of decoupling capacitors are connected in parallel to the inductor.

The decoupling apparatus is formed by lumped elements, and/or the decoupling apparatus is formed by a distributed parameter structure.

In this application, the inductor and the plurality of decoupling capacitors are disposed, so that a capacitance value of the decoupling capacitor of the decoupling apparatus is flexible and variable, to adapt to decoupling requirements of different frequencies. In this way, working performance and an application scope of the decoupling apparatus are improved.

A second aspect of this application provides an electronic device. The electronic device includes:
a body; and
an antenna assembly, where the antenna assembly is the antenna assembly according to any one of the foregoing designs, and the antenna assembly is electrically connected to the body through a feeding apparatus.

In this application, the antenna assembly can reduce interference between the first radiator and the second radiator that are adjacent to each other, so that working stability of the electronic device is improved.

It should be understood that the foregoing general description and the following detailed description are merely examples, and are not intended to limit this application.

### BRIEF DESCRIPTION OF DRAWINGS

FIG. 1 is a schematic diagram of a partial structure of an electronic device in an embodiment according to this application;

FIG. 2 is a schematic diagram of a structure of an antenna assembly in FIG. 1 in an embodiment;

FIG. 3 is a schematic diagram of a current flow direction of the antenna assembly in FIG. 2 when the antenna assembly undergoes common-mode feeding;

FIG. 4 is a schematic diagram of a current flow direction of the antenna assembly in FIG. 2 when the antenna assembly undergoes differential-mode feeding:

FIG. 5 is a schematic diagram of current distribution after decoupling of the antenna assembly in FIG. 2;

FIG. 6 is a schematic diagram of decoupling effect of an antenna assembly in an embodiment according to this application;

FIG. 7 is a schematic diagram of a structure of a decoupling apparatus of an antenna assembly in an embodiment according to this application;

FIG. 8 is a schematic diagram of a structure of a decoupling apparatus of an antenna assembly in another embodiment according to this application;

FIG. 9 is a schematic diagram of decoupling effect of an antenna assembly in another embodiment according to this application;

FIG. 10 is a schematic diagram of a structure of an antenna assembly in FIG. 1 in another embodiment;

FIG. 11 is a schematic diagram of a structure of an antenna assembly in FIG. 1 in another embodiment:

FIG. 12 is a schematic diagram of a structure of an antenna assembly in FIG. 1 in another embodiment;

FIG. 13 is a schematic diagram of a structure of an antenna assembly in FIG. 1 in another embodiment; and

FIG. 14 is a schematic diagram of a structure of an antenna assembly in FIG. 1 in another embodiment.

### REFERENCE NUMERALS

1—antenna assembly;
   11—first radiator;
      111—first radiation branch;
      112—second radiation branch;
      113—first gap;
      114—fifth radiation branch;
      115—first space;
   12—second radiator;
      121—third radiation branch;
      122—fourth radiation branch;
      123—second gap;
      124—sixth radiation branch;
      125—second space;
   13—common branch;
   14—feeding structure;
   15—decoupling apparatus;
      151—decoupling capacitor;
      152—inductor;
   16—grounding terminal;
   17—first protrusion part;
   18—second protrusion part;
2—body.

The accompanying drawings are incorporated in this specification and constitute a part of this specification, show embodiments conforming to this application, and are used together with this specification to explain the principle of this application.

### DESCRIPTION OF EMBODIMENTS

To better understand the technical solutions of this application, the following describes embodiments of this application in detail with reference to the accompanying drawings.

Although this application is described with reference to embodiments, it does not mean that a characteristic of this application is limited only to this implementation. On the contrary, a purpose of describing this application with reference to an implementation is to cover another option or modification that may be derived based on claims of this application. To provide an in-depth understanding of this application, the following descriptions include a plurality of specific details. This application may be alternatively implemented without using these details. In addition, to avoid confusion or blurring a focus of this application, some specific details are omitted from the description. It should be noted that embodiments in this application and features in embodiments may be mutually combined in the case of no conflict.

In embodiments of this application, the terms “first”, “second”, “third”, and “fourth” are merely intended for a purpose of description, and shall not be understood as an indication or implication of relative importance or an implicit indication of a quantity of indicated technical features. Therefore, a feature limited by “first”, “second”, “third”, and “fourth” may explicitly or implicitly include one or more features.

The term “and/or” in embodiments of this application describes only an association relationship for describing associated objects and represents that three relationships may exist. For example. A and/or B may represent the following three cases: Only A exists, both A and B exist, and only B exists. In addition, the character “/” in this specification generally indicates an “or” relationship between the associated objects.

In the descriptions of embodiments of this application, it should be noted that terms “installation” and “connection” should be understood in a broad sense unless there is a clear stipulation and limitation. For example, “connection” may be a detachable connection, an un-detachable connection, a direct connection, or an indirect connection through an intermediate medium. Orientation terms mentioned in embodiments of this application, for example, “up”, “down”, “left”, “right”, “inside”, and “outside”, are merely directions based on the accompanying drawings. Therefore, the orientation terms are used to better and more clearly describe and understand embodiments of this application, instead of indicating or implying that a specified apparatus or element should have a specific orientation and be constructed and operated in a specific orientation. Therefore, this cannot be understood as a limitation on embodiments of this application. “A plurality of” means at least two.

Reference to “an embodiment”. “some embodiments”, or the like described in this specification indicates that one or more embodiments of this application include a specific feature, structure, or characteristic described with reference to the embodiment. Therefore, statements such as “in an embodiment”, “in some embodiments”, “in some other embodiments”, and “in other embodiments” that appear at different places in this specification do not necessarily refer to a same embodiment. Instead, the statements mean “one or more but not all of embodiments”, unless otherwise specifically emphasized in another manner. The terms “include”, “comprise”, “have”, and variants thereof all mean “include but are not limited to”, unless otherwise specifically emphasized in another manner.

In a specific embodiment, the following further describes this application in detail with reference to specific embodiments and the accompanying drawings.

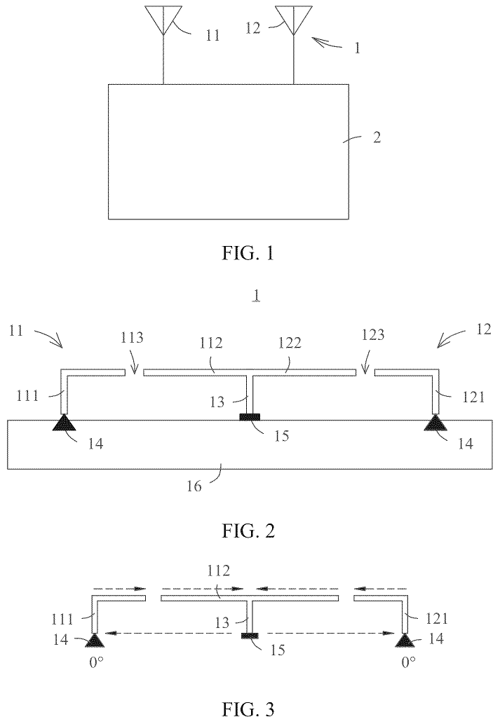

A first aspect of the embodiments of this application provides an electronic device. As shown in FIG. 1, the electronic device includes a body 2 and an antenna assembly 1. At least a part of the antenna assembly 1 is electrically connected to the body 2 or is connected to the body 2 in a form of signal. When the electronic device works, the antenna assembly 1 can receive or send a signal, to implement signal transmission between the electronic device and the outside. To increase an amount of data that can be processed by the electronic device, the antenna assembly 1 includes at least a first radiator 11 and a second radiator 12 that can work in a same frequency band at the same time. In addition, both the first radiator 11 and the second radiator 12 have a plurality of working frequency bands, so that the antenna assembly 1 can transmit signals of different frequencies. In this way, application scenarios of the electronic device increase. In the conventional technology, when the first radiator 11 and the second radiator 12 work in a same frequency band at the same time, the first radiator 11 and the second radiator 12 that are adjacent to each other interfere with each other. Consequently, quality of signals transmitted by the first radiator 11 and the second radiator 12 decreases, and stability of receiving and sending signals of the electronic device is reduced. However, the antenna assembly 1 provided in this application can reduce interference between the first radiator 11 and the second radiator 12 that are adjacent to each other, so that working stability of the electronic device is improved.

The body 2 connected to the antenna assembly 1 may be a metal housing, a circuit board, a copper sheet, or the like of the electronic device. A specific structure of the body 2 is not specifically limited in this application.

Specifically, as shown in FIG. 2, the antenna assembly 1 includes a first radiator 11, a second radiator 12, a feeding structure 14, and a decoupling apparatus 15. The first radiator 11 includes a first radiation branch 111 and a second radiation branch 112 that have opposite bending directions, and a first gap 113 exists between the first radiation branch 111 and the second radiation branch 112. The second radiator 12 includes a third radiation branch 121 and a fourth radiation branch 122 that have opposite bending directions, and a second gap 123 exists between the third radiation branch 121 and the fourth radiation branch 122. The first radiator 11 and the second radiator 12 share a common part, and the common part is a common branch 13. The decoupling apparatus 15 is disposed on the common branch 13, and the common branch 13 is electrically connected to a grounding terminal 16 of the antenna assembly 1 through the decoupling apparatus 15. The feeding structure 14 is separately electrically connected to the first radiation branch 111 and the third radiation branch 121.

In this embodiment, the antenna assembly 1 includes at least the first radiator 11 and the second radiator 12, and the first radiator 11 and the second radiator 12 can work in a same frequency band at the same time. When the antenna assembly 1 works, the first radiator 11 and the second radiator 12 can resonate with a signal of a specific frequency at the same time, and transmit a received signal to a chip of the electronic device by using the feeding structure 14, so that the electronic device performs identification processing on the signal. The first radiator 11 and the second radiator 12 resonate with a signal of a same frequency at the same time, the first radiator 11 and second radiator 12 that are adjacent to each other interfere with each other, and consequently quality of signals transmitted by the first radiator 11 and the second radiator 12 decreases. Therefore, in this embodiment of this application, the decoupling apparatus 15 is disposed on the common branch 13 of the first radiator 11 and the second radiator 12, and interference between the first radiator 11 and the second radiator 12 is reduced by using the decoupling apparatus 15. In this way, quality of signals transmitted by the first radiator 11 and the second radiator 12 is improved, stability of receiving and sending a signal by the electronic device is improved, accuracy of signal processing performed by the electronic device is improved, and use performance of the electronic device is improved. The decoupling apparatus 15 is disposed on the common branch 13 of the first radiator 11 and the second radiator 12, so that the decoupling apparatus 15 can reduce interference from the first radiator 11 to the second radiator 12 and interference from the second radiator 12 to the first radiator 11. In this way, working stability of the first radiator 11 and the second radiator 12 is improved, utilization of the decoupling apparatus 15 is improved, and structural complexity of the antenna assembly 1 is reduced. Therefore, a size of the antenna assembly 1 is reduced, and space required for installing the antenna assembly 1 is reduced.

The first radiator 11 includes a first radiation branch 111 and a second radiation branch 112 that have opposite bending directions, and a first gap 113 exists between the first radiation branch 111 and the second radiation branch 112. The second radiator 12 includes a third radiation branch 121 and a fourth radiation branch 122 that have opposite bending directions, and a second gap 123 exists between the third radiation branch 121 and the fourth radiation branch 122. In this way, the first radiator 11 and the second radiator 12 can resonate with signals of a plurality of frequencies, resulting in a wider frequency range of signals transmitted by the first radiator 11 and the second radiator 12, more application scenarios of the electronic device, and improved working performance of the antenna assembly 1 and the electronic device.

In addition, a connection manner between the feeding structure 14 and the radiators (the radiators are the first radiator 11 and the second radiator 12) may be a direct connection, or may be a coupled connection. The connection manner between the feeding structure 14 and the radiators is not specially limited in this application.

Specifically, the decoupling apparatus 15 includes one or more decoupling capacitors 151.

In this embodiment, when the first radiator 11 resonates with a signal of a specific frequency, energy is generated and radiated to the outside. In this case, the decoupling capacitor 151 can absorb some energy radiated by the first radiator 11, to prevent the energy radiated by the first radiator 11 from interfering with resonance between the second radiator 12 and the signal, so that working stability of the second radiator 12 is improved.

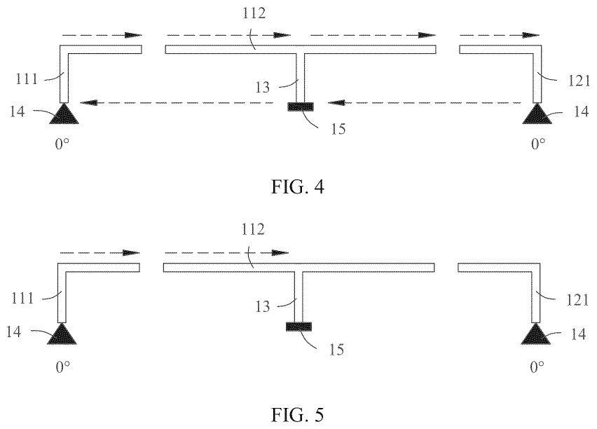

A specific method for determining a capacitance value of the decoupling capacitor 151 is as follows: First, as shown in FIG. 3, common-mode feeding is performed on the first radiator 11 and the second radiator 12. That is, a phase of an excitation signal applied on the first radiator 11 is the same as a phase of an excitation signal applied on the second radiator 12. In this case, a current direction on the first radiator 11 is opposite to a current direction on the second radiator 12. In addition, a current direction on the first radiation branch 111 is the same as a current direction on the second radiation branch 112, a current direction on the third radiation branch 121 is the same as a current direction on the fourth radiation branch 122, a current direction on the grounding terminal 16 of the antenna assembly 1 is opposite to the current direction on the first radiator 11, a current direction on the grounding terminal 16 is opposite to the current direction on the second radiator 12, and a position of the decoupling capacitor 151 is exactly a maximum current point of the common-mode feeding. Then, as shown in FIG. 4, differential-mode feeding is performed on the first radiator 11 and the second radiator 12. That is, the phase of the excitation signal applied on the first radiator 11 is opposite to the phase of the excitation signal applied on the second radiator 12. In this case, the current direction on the first radiator 11 is the same as the current direction on the second radiator 12. In addition, the current direction on the first radiation branch 111, the current direction on the second radiation branch 112, the current direction on the third radiation branch 121, and the current direction on the fourth radiation branch 122 are the same, and the current direction on the grounding terminal 16 is the same as the current direction on the first radiator 11 and the current direction on the second radiator 12. In this case, the position of the decoupling capacitor 151 is exactly a minimum current point of the differential-mode feeding. Finally, as shown in FIG. 5, the capacitance value of the decoupling capacitor 151 is adjusted, so that a current for common-mode feeding and a current for differential-mode feeding are added on the first radiator 11 and canceled on the second radiator 12. In this way, a risk that a current generated by resonance between the first radiator 11 and a signal enters the second radiator 12 is reduced, and interference from the first radiator 11 to the second radiator 12 is reduced. Similarly, the current for common-mode feeding and the current for differential-mode feeding are added on the second radiator 12 and canceled on the first radiator 11, so that interference caused by the second radiator 12 to the first radiator 11 can be reduced. The first radiator 11 and the second radiator 12 have at least a first working frequency band and a second working frequency band, so that the foregoing steps are repeated to separately obtain a value range of the decoupling capacitor 151 in the first operating frequency band and a value range of the decoupling capacitor 151 in the second operating frequency band. A common capacitance value in a plurality of value ranges is selected, so that the decoupling capacitor 151 can decouple the antenna assembly 1 in the plurality of frequency bands. In this way, a risk of a failure of the decoupling capacitor 151 caused by a change in a frequency of a signal transmitted by the first radiator 11 and the second radiator 12 is reduced, working stability of the decoupling capacitor 151 is improved, and working stability of the decoupling apparatus 15 and the antenna assembly 1 is improved.

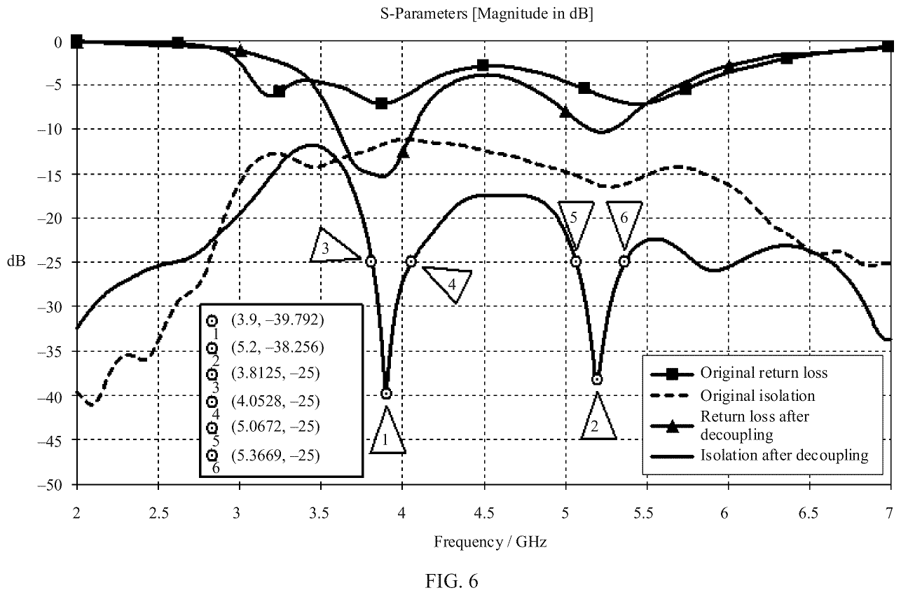

In this embodiment, the antenna assembly 1 can transmit signals of a frequency of 3.9 GHz and a frequency of 5.2 GHz. As shown in FIG. 6, when the antenna assembly 1 transmits a signal of the frequency of 3.9 GHz, an isolation ratio of the decoupling apparatus 15 is 39.8 dB, which is improved by 27.4 dB compared with an isolation ratio when decoupling is not performed. When the antenna assembly 1 transmits a signal of the frequency of 5.2 GHz, an isolation ratio of the decoupling apparatus 15 is 38.2 dB, which is improved by 23.9 dB compared with the isolation ratio when decoupling is not performed. In addition, as shown in FIG. 6, the decoupling apparatus 15 is disposed, so that the isolation ratio between the first radiator 11 and the second radiator 12 is improved, and impedance matching between the first radiator 11 and the second radiator 12 is improved. This further improves working performance of the antenna assembly 1.

The plurality of decoupling capacitors 151 may be connected in series or in parallel. A series-parallel connection form of the decoupling capacitors 151 is not specially limited in this application.

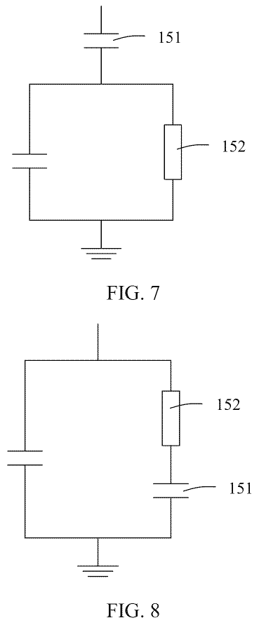

More specifically, as shown in FIG. 7 and FIG. 8, the decoupling apparatus 15 includes an inductor 152 and the decoupling capacitor 151. There are one or more decoupling capacitors 151, and there are one or more inductors 152. The decoupling capacitor 151 is connected to the inductor 152 in series, and/or the decoupling capacitor 151 is connected to the inductor 152 in parallel.

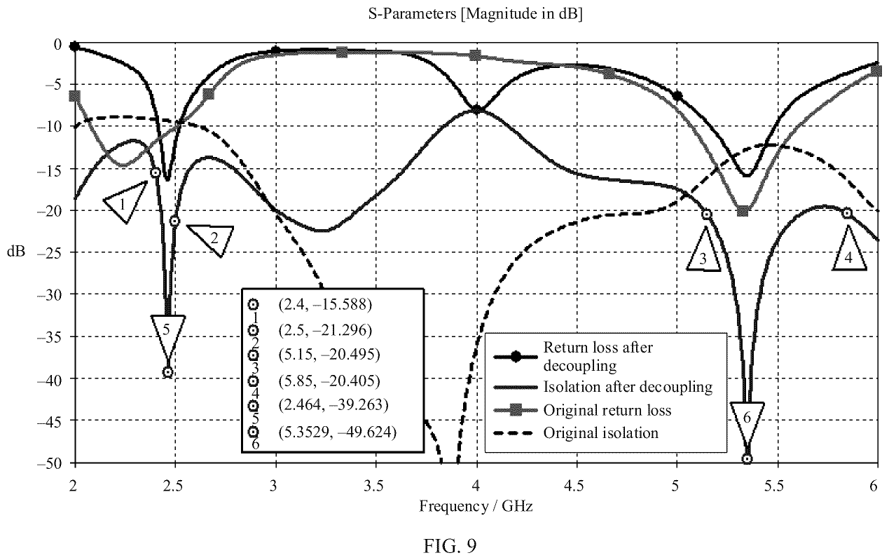

In this embodiment, the inductor 152 and the decoupling capacitor 151 are disposed, so that a capacitance value of the decoupling capacitor 151 of the decoupling apparatus 15 is flexible and variable, to adapt to decoupling requirements of different frequencies. In this way, working performance and an application scope of the decoupling apparatus 15 are improved. As shown in FIG. 9, when the antenna assembly 1 in this embodiment transmits signals of a 2.4 GHz frequency and a 5 GHz frequency, two decoupling resonances can be generated at the same time. When the antenna assembly 1 transmits a signal of the 2.4 GHz frequency, an isolation ratio of the decoupling apparatus 15 is better than 15 dB, and the isolation ratio of the decoupling apparatus 15 may reach a maximum of 39 dB, which is improved by 29.5 dB compared with the isolation ratio when decoupling is not performed. An isolation ratio of a signal edge of the 2.4 GHz frequency signal is 15.6 dB, and an isolation ratio of a signal edge of the 2.5 GHz frequency signal is 21.3 dB, which are respectively improved by 6.5 dB and 11.8 dB compared with the isolation ratios when decoupling is not performed. When the antenna assembly 1 transmits the signal of the 5 GHz frequency, the isolation ratio of the decoupling apparatus 15 is better than 20 dB, and the isolation ratio of the decoupling apparatus 15 may reach a maximum of 50 dB, which is improved by 37 dB compared with the isolation ratio when decoupling is not performed. Isolation ratios of signal edges of 5.15 GHz frequency and 5.85 GHz frequency signals are about 20 dB, which are improved by 8.5 dB compared with the isolation ratios when decoupling is not performed.

A series-parallel connection form of the decoupling capacitor 151 and the inductor 152 is flexible and variable. The series-parallel connection form of the decoupling capacitor 151 and the inductor 152 is not specially limited in this application.

In addition, the decoupling apparatus 15 described in any one of the foregoing embodiments includes but is not limited to being implemented by lumped elements, and/or implemented by a distributed parameter structure. An implementation of the decoupling capacitor 151 is not specifically limited in this application.

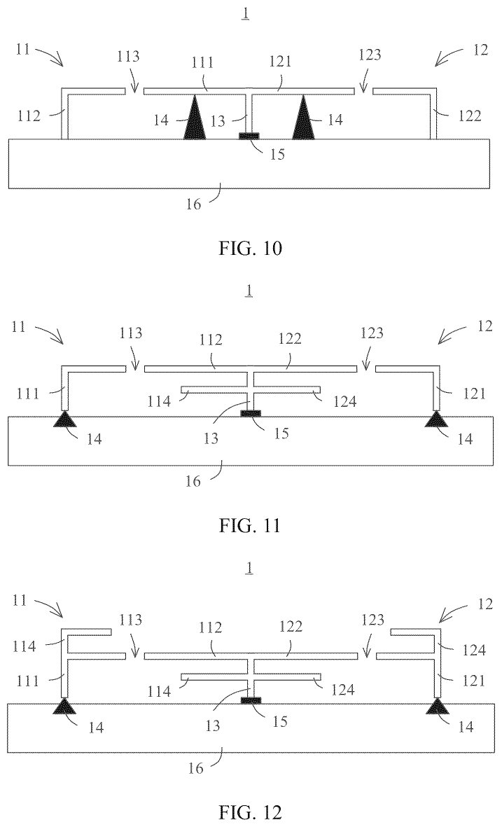

An embodiment of this application further provides a plurality of deformation structures of the antenna assembly 1. In an embodiment, as shown in FIG. 2, the second radiation branch 112 and the fourth radiation branch 122 are integrally arranged to form the common branch 13, and the second radiation branch 112 and the fourth radiation branch 122 join into a T-shaped structure. In another embodiment, as shown in FIG. 10, the first radiation branch 111 and the third radiation branch 121 are integrally arranged to form the common branch 13, and the first radiation branch 111 and the third radiation branch 121 join into a T-shaped structure.

In this embodiment, the first radiation branch 111 and the third radiation branch 121 may be integrally arranged, or the second radiation branch 112 and the fourth radiation branch 122 may be integrally arranged. As shown in FIG. 2, when the second radiation branch 112 and the fourth radiation branch 122 are integrally arranged, the first radiation branch 111 is located on a side away from the second radiator 12, and the third radiation branch 121 is located on a side away from the first radiator 11. In this case, the feeding structure 14 is located on an outer side of the first radiator 11 and the second radiator 12, so that the feeding structure 14 is connected to the first radiation branch 111 and the third radiation branch 121. As shown in FIG. 10, when the first radiation branch 111 and the third radiation branch 121 are integrally arranged, the second radiation branch 112 is located on a side away from the second radiator 12, and the fourth radiation branch 122 is located on a side away from the first radiator 11. In this case, at least a part of the feeding structure 14 is located on an inner side of the first radiator 11 and the second radiator 12. It can be learned that the second radiation branch 112 and the fourth radiation branch 122 are integrally arranged, or the first radiation branch 111 and the third radiation branch 121 are integrally arranged. This increases flexibility of a structure of the antenna assembly 1, and increases flexibility of an installation position of the feeding structure 14, to facilitate installation of the antenna assembly 1. In addition, the installation position of the feeding structure 14 is changed, so that a coupling relationship between the first radiation branch 111 and the second radiation branch 112 and a coupling relationship between the third radiation branch 121 and the fourth radiation branch 122 can be changed. In this way, interference between the first radiator 11 and the second radiator 12 is reduced, and working stability of the first radiator 1I and the second radiator 12 is improved.

When the first radiation branch 111 and the third radiation branch 121 are integrally arranged, the decoupling apparatus 15 generates three decoupling resonances, which are respectively located at a 3.4 GHz frequency, a 5.6 GHz frequency, and a 6 GHz frequency. An isolation ratio at the 3.4 GHz frequency is increased to 33 dB, and the decoupling resonances at the 5.6 GHz frequency and the 6 GHz frequency forms a 30 dB isolation bandwidth that exceeds 600 MHz. It can be seen that when the first radiation branch 111 and the third radiation branch 121 are integrally arranged, dual-frequency decoupling can be implemented, and a broadband decoupling requirement of 5G can be met.

The second radiation branch 112 and the fourth radiation branch 122 that are integrally arranged join into a T-shaped structure, or the first radiation branch 111 and the third radiation branch 121 that are integrally arranged join into a T-shaped structure. In this way, structures of the second radiation branch 112, the fourth radiation branch 122, the first radiation branch 111, and the third radiation branch 121 are simplified, a size of the antenna assembly 1 is reduced, and space required for installing the antenna assembly 1 is reduced. In addition, the two radiation branches that are integrally arranged may also join into a Y-shaped structure. A structure of the two radiation branches that are integrally arranged is not specially limited in this application.

More specifically, as shown in FIG. 11 and FIG. 12, the first radiator 11 further includes at least one fifth radiation branch 114. The fifth radiation branch 114 is connected to the first radiation branch 111, and/or the fifth radiation branch 114 is connected to the second radiation branch 112. The second radiator 12 further includes at least one sixth radiation branch 124. The sixth radiation branch 124 is connected to the third radiation branch 121, and/or the sixth radiation branch 124 is connected to the fourth radiation branch 122.

In this embodiment, both the first radiator 11 and the second radiator 12 include a plurality of radiation branches that can resonate with a signal of a specific frequency, to widen a frequency range of signals that can be transmitted by the first radiator 11 and the second radiator 12. In this way, working performance of the first radiator 11 and the second radiator 12 is improved, and working performance and an application scope of the antenna assembly 1 and the electronic device are improved. A quantity, a size, an installation position, a bending direction, and the like of the fifth radiation branch 114 and the sixth radiation branch 124 are not specially limited in this application.

In an embodiment, as shown in FIG. 12, the at least one fifth radiation branch 114 and the at least one sixth radiation branch 124 are connected to the common branch 13. The fifth radiation branch 114 and the sixth radiation branch 124 divide the common branch 13 into a plurality of segments. There is one decoupling apparatus 15, and the decoupling apparatus 15 is disposed on a segment that is of the common branch 13 and that is close to the grounding terminal 16.

In this embodiment, the decoupling apparatus 15 is disposed on the segment that is of the common branch 13 and that is close to the grounding terminal 16. That is, a plurality of radiation branches on the common branch 13 are all connected to the grounding terminal 16 through the decoupling apparatus 15, so that when the antenna assembly 1 works in any frequency band, the decoupling apparatus 15 can decouple the antenna assembly 1. In this way, working reliability of the decoupling apparatus 15 is improved, and working stability of the antenna assembly 1 and the electronic device is improved.

A single decoupling apparatus 15 generates three decoupling resonances, which are respectively located at a 3.39 GHz frequency, a 4 GHz frequency, and a 5.56 GHz frequency. When a frequency of a signal transferred by the antenna assembly 1 is 3.39 GHz, an isolation ratio of the antenna assembly 1 is 33 dB. When the frequency of the signal transferred by the antenna assembly 1 is 4 GHz, the isolation ratio of the antenna assembly 1 is 32.5 dB. And when the frequency of the signal transferred by the antenna assembly 1 is 5.56 GHz, the isolation ratio of the antenna assembly 1 is 45 dB. The decoupling resonances of 3.39 GHz and 5.56 GHz are generated by the first radiation branch 111 and the second radiation branch 112, and 25 dB isolation relative bandwidths are 4.4% (3.32 GHz to 3.47 GHz) and 6.6% (5.4 GHz to 5.77 GHz) respectively. The decoupling resonance of 4G is generated by a parasitic branch, and the bandwidth is relatively narrow. Therefore, it can be basically considered that only the frequency effect is achieved.

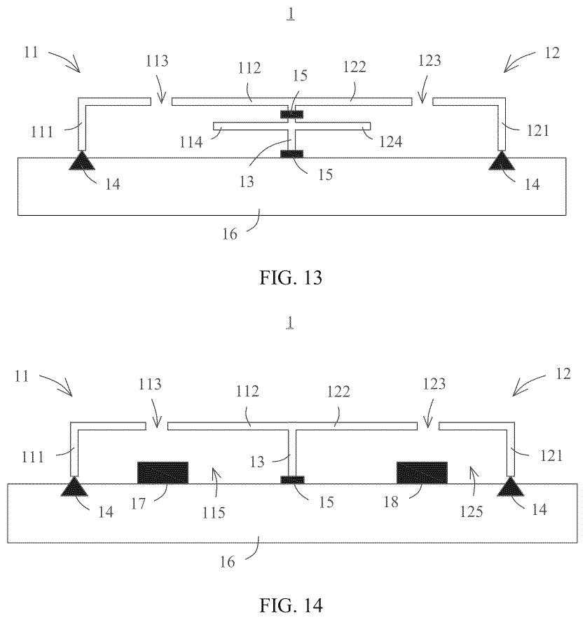

In another embodiment, as shown in FIG. 13, the at least one fifth radiation branch 114 and the at least one sixth radiation branch 124 are connected to the common branch 13, the fifth radiation branch 114 and the sixth radiation branch 124 divide the common branch 13 into a plurality of segments. There are a plurality of decoupling apparatuses 15, and the decoupling apparatuses 15 are disposed on each segment of the common branch 13.

In this embodiment, as shown in FIG. 13, when the second radiation branch 112 resonates with a signal of a specific frequency, all decoupling apparatuses 15 between the second radiation branch 112 and the grounding terminal 16 work together. When a fifth radiation branch 114 resonates with a signal of a specific frequency, all decoupling apparatuses 15 between the fifth radiation branch 114 and the grounding terminal 16 work together. In this case, the decoupling apparatus 15 located on the outer side of the fifth radiation branch 114 is in a non-working state. The decoupling apparatus 15 is disposed on each segment of the common branch 13. When one decoupling apparatus 15 is short-circuited, other decoupling apparatuses 15 can also work normally. In this way, working reliability of the decoupling apparatus 15 is improved, and working stability of the antenna assembly 1 and the electronic device is improved.

In another embodiment, as shown in FIG. 14, the first radiation branch 111, the second radiation branch 112, and the grounding terminal 16 enclose a first space 115, and the third radiation branch 121, the fourth radiation branch 122, and the grounding terminal 16 enclose a second space 125. The antenna assembly 1 further includes at least one first protrusion part 17 and at least one second protrusion part 18. Both the first protrusion part 17 and the second protrusion part 18 are connected to the grounding terminal 16. The first protrusion part 17 is disposed in the first space 115, and the second protrusion part 18 is disposed in the second space 125.

In this embodiment, the at least one first protrusion part 17 is disposed in the first space 115, and the at least one second protrusion part 18 is disposed in the second space 125, to change a distance between the first radiator 11 and the grounding terminal 16, and a distance between the second radiator 12 and the grounding terminal 16. Therefore, a coupling relationship between the first radiation branch 111 and the second radiation branch 112 is changed, and a coupling relationship between the third radiation branch 121 and the fourth radiation branch 122 is changed. In this way, decoupling resonance of the first radiator 1I and the second radiator 12 moves toward a low frequency at the same time, and moves from 3.9 GHz and 5.2 GHz to 3.6 GHz and 4.5 GHz respectively, and a relative frequency multiplication relationship of dual decoupling resonance decreases from 1.33 to 1.25. It can be learned that a decoupling resonance spacing between the first radiator 11 and the second radiator 12 is reduced. That is, interference between the first radiator 11 and the second radiator 12 is reduced, and working stability of the first radiator 11 and the second radiator 12 is improved.

Cross sections of the first protrusion part 17 and the second protrusion part 18 may be in shapes such as a rectangle, a semicircle, a triangle, or the like. Shapes of the cross sections of the first protrusion part 17 and the second protrusion part 18 are not specially limited in this application. The first protrusion part 17 and the second protrusion part 18 may be fastened to the grounding terminal 16 or integrally formed with the grounding terminal 16, to increase flexibility of structures of the first protrusion part 17, the second protrusion part 18, and the grounding terminal 16.

In addition, the operating frequency band of the antenna assembly 1 in any one of the foregoing embodiments is an example for description. The operating frequency band of the antenna assembly 1 is not specially limited in this application.

It should be noted that a part of this patent application document includes copyright-protected content. The copyright owner reserves the copyright except copies are made for the patent documents or the recorded content of the patent documents in the Intellectual Property Administration.

1. An antenna assembly comprising:
a grounding terminal;
a common branch electrically coupled to the grounding terminal;
a first radiator comprising:
a first radiation branch;
a second radiation branch, wherein the first radiation branch and the second radiation branch have opposite bending directions; and
a first gap between the first radiation branch and the second radiation branch;
a second radiator comprising:
a third radiation branch; and
a fourth radiation branch, wherein the third radiation branch and the fourth radiation branch have opposite bending directions; and
a second gap between the third radiation branch and the fourth radiation branch, wherein the first radiator and the second radiator share the common branch;
a feeding structure is electrically coupled to the first radiation branch and the third radiation branch; and
a decoupling apparatus disposed on the common branch such that the common branch electrically couples to the grounding terminal through the decoupling apparatus.

2. The antenna assembly of claim 1, wherein the first radiation branch and the third radiation branch are integrally arranged to form the common branch, or wherein the second radiation branch and the fourth radiation branch are integrally arranged to form the common branch.

3. The antenna assembly of claim 2, wherein the first radiation branch and the third radiation branch are integrally arranged into a first T-shaped structure, or wherein the second radiation branch and the fourth radiation branch are integrally arranged into a second T-shaped structure.

4. The antenna assembly of claim 2, wherein the first radiator further comprises at least one fifth radiation branch coupled to the first radiation branch or the second radiation branch, and wherein the second radiator further comprises at least one sixth radiation branch coupled to the third radiation branch or the fourth radiation branch.

5. The antenna assembly of claim 4, wherein the at least one fifth radiation branch and the at least one sixth radiation branch are further coupled to the common branch and configured to divide the common branch into first segments, and wherein the decoupling apparatus is disposed on a second segment of the first segments that is proximate to the grounding terminal.

6. The antenna assembly of claim 4, further comprising a plurality of decoupling apparatuses, wherein the at least one fifth radiation branch and the at least one sixth radiation branch are further coupled to the common branch and configured to divide the common branch into segments, and wherein each of the decoupling apparatuses is disposed on each of the segments.

7. The antenna assembly of claim 2, wherein the first radiation branch, the second radiation branch, and the grounding terminal are configured to enclose a first space, wherein the third radiation branch, the fourth radiation branch, and the grounding terminal are configured to enclose a second space, and wherein the antenna assembly further comprises:
at least one first protrusion part disposed in the first space and coupled to the grounding terminal; and
at least one second protrusion part disposed in the second space and coupled to the grounding terminal.

8. The antenna assembly of claim 1, wherein the decoupling apparatus comprises one or more decoupling capacitors and is formed by lumped elements or a distributed parameter structure.

9. The antenna assembly of claim 1, wherein the decoupling apparatus comprises:
one or more decoupling capacitors; and
one or more inductors,
wherein each of the one or more decoupling capacitors is coupled in series to the one or more inductors, and
wherein the decoupling apparatus is formed by lumped elements or a distributed parameter structure.

10. An electronic device comprising:
a body; and
an antenna assembly electrically coupled to the body and comprising:
a grounding terminal;
a common branch electrically coupled to the grounding terminal;
a first radiator comprising:
a first radiation branch;
a second radiation branch, wherein the first radiation branch and the second radiation branch have opposite bending directions; and
a first gap between the first radiation branch and the second radiation branch;
a second radiator comprising:
a third radiation branch;
a fourth radiation branch, wherein the third radiation branch and the fourth radiation branch have opposite bending directions; and
a second gap between the third radiation branch and the fourth radiation branch, wherein the first radiator and the second radiator share the common branch;
a feeding structure electrically coupled to the first radiation branch and the third radiation branch and configured to couple the antenna assembly to the electronic device; and
a decoupling apparatus disposed on the common branch such that the common branch electrically couples to the grounding terminal through the decoupling apparatus.

11. The electronic device of claim 10, wherein the first radiation branch and the third radiation branch are integrally arranged to form the common branch, or wherein the second radiation branch and the fourth radiation branch are integrally arranged to form the common branch.

12. The electronic device of claim 11, wherein the first radiation branch and the third radiation branch are integrally arranged into a first T-shaped structure, or wherein the second radiation branch and the fourth radiation branch are integrally arranged into a second T-shaped structure.

13. The electronic device of claim 11, wherein the first radiator further comprises at least one fifth radiation branch coupled to the first radiation branch or the second radiation branch, and wherein the second radiator further comprises at least one sixth radiation branch coupled to the third radiation branch or the fourth radiation branch.

14. The electronic device of claim 13, wherein the at least one fifth radiation branch and the at least one sixth radiation branch are further coupled to the common branch and configured to divide the common branch into first segments, and wherein the decoupling apparatus is disposed on a second segment of the first segments that is proximate to the grounding terminal.

15. The electronic device of claim 13, further comprising a plurality of decoupling apparatuses, wherein the at least one fifth radiation branch and the at least one sixth radiation branch are further coupled to the common branch and configured to divide the common branch into segments, and wherein each of the decoupling apparatuses is disposed on each of the segments.

16. The electronic device of claim 11, wherein the first radiation branch, the second radiation branch, and the grounding terminal are configured to enclose a first space, wherein the third radiation branch, the fourth radiation branch, and the grounding terminal are configured to enclose a second space, and wherein the antenna assembly further comprises:
at least one first protrusion part disposed in the first space and coupled to the grounding terminal; and
at least one second protrusion part disposed in the second space and coupled to the grounding terminal.

17. The electronic device of claim 10, wherein the decoupling apparatus comprises one or more decoupling capacitors and is formed by lumped elements or a distributed parameter structure.

18. The electronic device of claim 10, wherein the decoupling apparatus comprises:
one or more decoupling capacitors; and
one or more inductors,
wherein each of the one or more decoupling capacitors is coupled in series to the one or more inductors, and
wherein the decoupling apparatus is formed by lumped elements or a distributed parameter structure.

19. The electronic device of claim 10, wherein the decoupling apparatus comprises:
one or more decoupling capacitors; and
one or more inductors,
wherein each of the one or more decoupling capacitors is coupled in parallel to the one or more inductors, and
wherein the decoupling apparatus is formed by lumped elements or a distributed parameter structure.

20. The antenna assembly of claim 1, wherein the decoupling apparatus comprises:
one or more decoupling capacitors; and
one or more inductors,
wherein each of the one or more decoupling capacitors is coupled in parallel to the one or more inductors, and
wherein the decoupling apparatus is formed by lumped elements or a distributed parameter structure.
